(19) United States
(12) Patent Application Publication
(10) Pub. No.: US 2003/0212603 A1
(43) Pub. Date: Nov. 13, 2003

(54) System and method for creating a purchase order for combination items, and storage media in which a program for creating information on combination items is recorded

(76) Inventor: Masahiro Arita, Osaka (JP)

Correspondence Address: ROTHWELL, FIGG, ERNST & MANBECK, P.C., 1425 K STREET, N.W., SUITE 800, WASHINGTON, DC, 20005, US

(21) Appl. No.: 09/871,149

(22) Filed: Jun. 1, 2001

(30) Foreign Application Priority Data
Jun. 2, 2000 (JP) 2000-166567

(51) Int. Cl. G06F 17/60

(52) U.S. Cl. 705/26

(57) ABSTRACT

A predetermined information is transmitted to a server system through a computer network from a customer system. In the server system, the predetermined information is received and each information on previously stored content are selectively combined based on the predetermined information to create information concerning combination items. The information concerning the combination items will be transmitted to the customer system via the Internet. In the customer system, the information concerning the combination items is received, a purchase order for the combination items is generated and transmitted to the server system.

### BACKGROUND OF THE INVENTION

1. Field of the Invention

The present invention relates to a system and a method for creating a purchase order for combination items and a storage media in which a program for creating information on combination items is recorded. The present invention relates more specifically to a system and a method for creating a purchase order for combination items such as a combination of flowers, a combination of dresses and a combination of foods, based on information concerning a customer, and a storage media in which a program for creating information on combination items is recorded.

2. Description of Related Art

In recent years, many systems which meet customer's various needs have been provided in accordance with the improvement of hardware of communication terminals such as general purpose computers and cellular phones and the spread of the Internet.

For example, a system by which a user can place a purchase order for combination of flowers created by selectively combining single flowers of several kinds (hereinafter referred to as “combination flowers”) via the Internet, is known. In this system, a customer connects his/her personal computer to a server computer via the Internet to watch the Homepage carrying information concerning combination flowers, such as photographs, flower names, explanations and price of the combination flowers. When the customer places a purchase order for combination flowers through the Internet, the combination flowers will be dispatched to the predetermined destination from the dealer tied up with the server of the system.

However, the aforementioned combination flowers carried on the Homepage are previously created combination flowers. Accordingly, a customer has no choice but to select one of combination flowers among them, which is not enough to enhance the incentive to customer's purchase order.

This kind of problem resides not only in combination flowers but also in various combination items (goods), which can be created by selectively combining components, such as a combination of dresses and a combination of foods.

### SUMMARY OF THE INVENTION

It is an object of the present invention to provide a system for generating a purchase order for combination items, which can increase an incentive to a customer's purchase order.

It is another object of the present invention to provide a storage media in which a program for creating information on combination items is recorded, which can increase an incentive to a customer's purchase order.

It is still another object of the present invention to provide a method for ordering combination items, which can increase an incentive to a customer's purchase order.

It is still yet another object of the present invention to provide a server system for generating a purchase order for combination items, which can increase an incentive to a customer's purchase order.

It is still yet another object of the present invention to provide a method for receiving a purchase order for combination items, which can increase an incentive to a customer's purchase order.

According to a first aspect of the present invention, a system generates a purchase order for combination items based on information concerning a customer. The system comprises customer information input means which inputs information concerning a customer, customer information storing means which stores the information concerning the customer inputted by the customer information input means, components storing means which stores information concerning components constituting the combination items, combination items information creating means which creates information concerning the combination items suitable for the customer by selectively combining the components stored in the components storing means based on the information concerning the customer stored in the customer information storing means, and combination items information output means which outputs the information concerning the combination items created by the combination items information creating means.

In this system, since the information concerning combination items is created by selectively combining components, a customer can place a purchase order for combination items meeting his/her needs, which increases an incentive to the customer's purchase order.

According to a second aspect of the present invention, a storage media in which a program for creating information on combination items is recorded is provided. The program executes the following means: customer information input means which inputs information concerning a customer, customer information storing means which stores the information concerning the customer inputted by the customer information input means, components storing means which stores information concerning components of combination items, combination items information creating means which creates information concerning combination items suitable for the customer by selectively combining the components constituting combination items stored in the component storing means based on the information concerning the customer stored in the customer information storing means; and combination items information output means which outputs the information concerning the combination items created by the combination items information creating means.

According to a third aspect of the present invention, a method of ordering combination items, comprises inputting information concerning a customer into a computer, creating information concerning combination items by selectively combining components constituting the combination items based on the information concerning the customer by the computer, and outputting the information concerning the combination items to a terminal of a dealer, whereby the dealer creates combination items based on the information concerning the combination items and provides the created combination items to the customer.

According to a fourth aspect of the present invention, a server system for creating a purchase order of combination items, comprises customer information storing means which stores information concerning a customer transmitted from a customer system, combination items component storing means which stores information concerning components of the combination items, combination items information creating means which creates information concerning combination items by selectively combining components stored in the component storing means based on the information concerning the customer stored in the customer information storing means, and information output means which outputs the information concerning the combination items to the customer system, wherein the server system generates a purchase order of the combination items according to an instruction from the customer system.

According to a fifth aspect of the present invention, a method for ordering combination items, comprises transmitting predetermined information to a server system through a computer network from a customer system,

in the server system:

receiving the predetermined information, creating information concerning combination items by selectively combining each previously stored information concerning components constituting the combination items based on the predetermined information, and transmitting the information concerning combination items to the customer system through the computer network,

in the customer system:

receiving the information concerning combination items, generating a purchase order for the combination items, and transmitting the order to the server system.

According to a sixth aspect of the present invention, a method for receiving a purchase order for combination items, comprises inputting information concerning a dealer into a server system through a computer network, and inputting predetermined information into the server system through the computer network from a customer system;

in the server system: creating information concerning combination items by selectively combining each previously stored information concerning components constituting the combination items based on the predetermined information, and transmitting the information concerning the combination items to the customer system through the computer network,

in the customer system: receiving information concerning the combination items, generating a purchase order for the combination items; and transmitting the order to the server system,

in the dealer system: receiving the order.

Other objects and the features will be apparent from the following detailed description of the present invention with reference to the attached drawings.

### BRIEF DESCRIPTION OF THE DRAWINGS

FIG. 1 is a structural schematic diagram showing a whole system including a server according to an embodiment of the present invention;

FIG. 2 is a block diagram showing the structure of the server shown in FIG. 1;

FIG. 3 is a flow chart showing a procedure of a dealer registration;

FIG. 4 is a flow chart showing the (first half) procedure for ordering items;

FIG. 5 is a flow chart showing the (second half) procedure for ordering items;

FIG. 6 shows a main menu screen;

FIG. 7 shows a dealer information input screen;

FIG. 8 shows a customer information input screen;

FIG. 9 shows a customer information confirmation screen;

FIG. 10 shows a combination items information screen;

FIG. 11 shows a component file showing the relationship between [symbol] (KUYOUSEI) and compositions (single flowers); and

FIG. 12 shows a component file showing the relationship between the purpose of use and components (single flowers).

### DETAILED DESCRIPTION OF THE PREFERRED EMBODIMENTS

A system for generating a purchase order for combination items according to an embodiment of the present invention, which is applied to a server on the Internet, will be explained with reference to the drawings.

In this embodiment, one or plural kinds of single flowers and flower shapes constitute “component,” and combination flowers created by selectively combining these components constitute “combination items or goods (hereinafter referred to as “combination items”).”

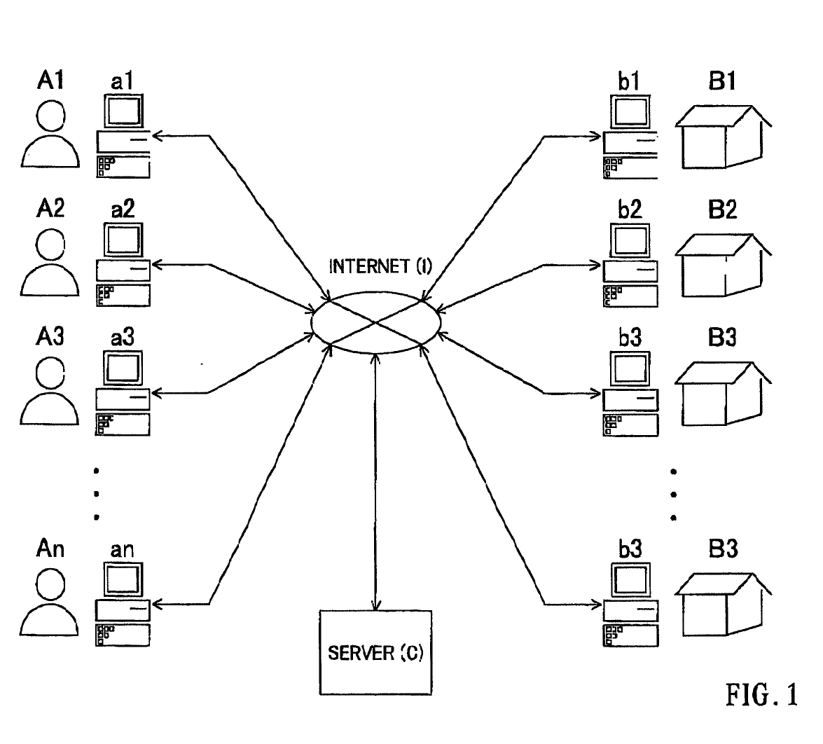

In FIG. 1, A1, A2 . . . and An denote a customer who places a purchase order for combination flowers, respectively. Each customer connects his/her personal computer a1, a2 . . . and an, which is regarded as a communication terminal, to a server C via the Internet I. B1, B2 . . . and Bn denote a dealer or a flower shop (hereinafter referred to as “dealer”) of combination flowers, respectively. Each dealer also connects its personal computer b1, b2 . . . and bn, which is regarded as a communication terminal, to the server C via the Internet I.

Each of the personal computers an and bn includes a display such as a CRT (Cathode-ray tube) and an LCD (liquid crystal display), a keyboard, a mouse, etc.

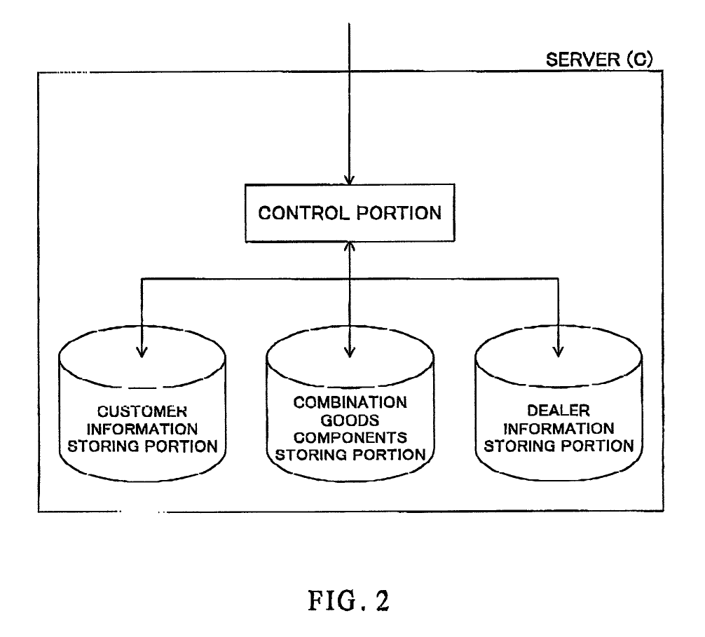

As shown in FIG. 2, the aforementioned server C includes a control portion 2, a customer information storing portion 3, a component storing portion 4 and a dealer information storing portion 5.

The customer information storing portion 3 stores information concerning each customer An (hereinafter “customer information”) in a file format.

This customer information file includes a customer's address, name, telephone number, e-mail address, birth date and family relationship and purpose for using combination items.

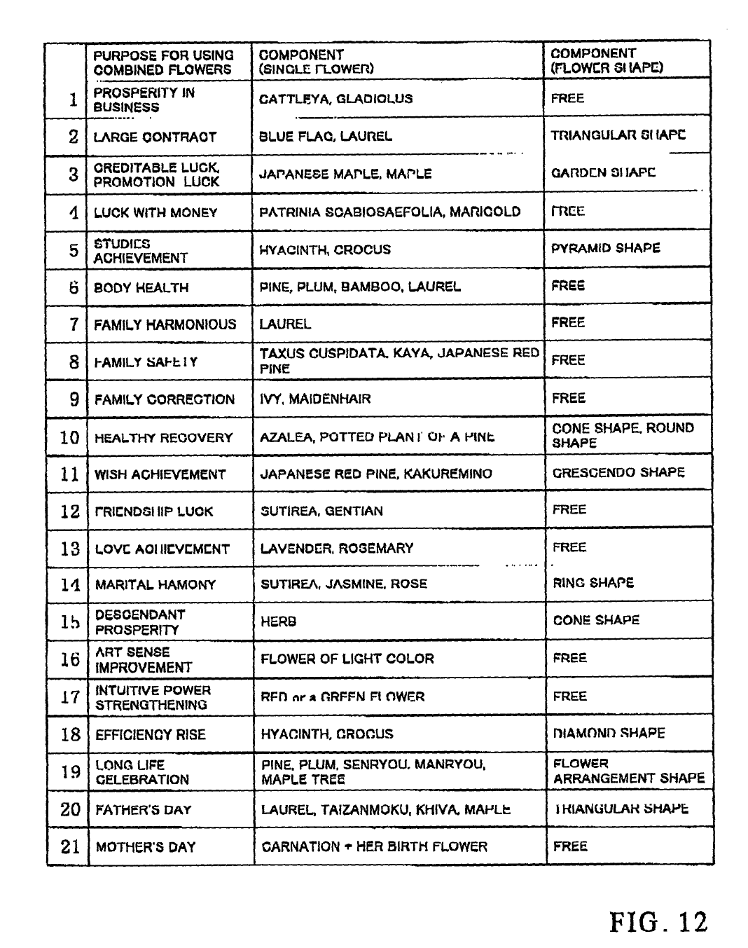

As shown in FIG. 12, purposes for using combination items are classified into a total of 21 items, i.e., “PROSPERITY IN BUSINESS,” “LARGE CONTRACT,” “CREDITABLE LUCK/PROMOTION LUCK,” “LUCK WITH MONEY,” “STUDIES ACHIEVEMENT,” “BODY HEALTH,” “FAMILY HARMONIOUS,” “FAMILY SAFETY,” “FAMILY CORRECTION,” “HEALTHY RECOVERY,” “WISH ACHIEVEMENT,” “FRIENDSHIP LUCK,” “LOVE ACHIEVEMENT,” “MARITAL HARMONY,” “DESCENDANT PROSPERITY,”0 “ART SENSE IMPROVEMENT,” “INTUITIVE POWER STRENGTHENING,” “EFFICIENCY RISE,” “LONG LIFE CELEBRATION,” “FATHER'S DAY” and “MOTHER'S DAY.”

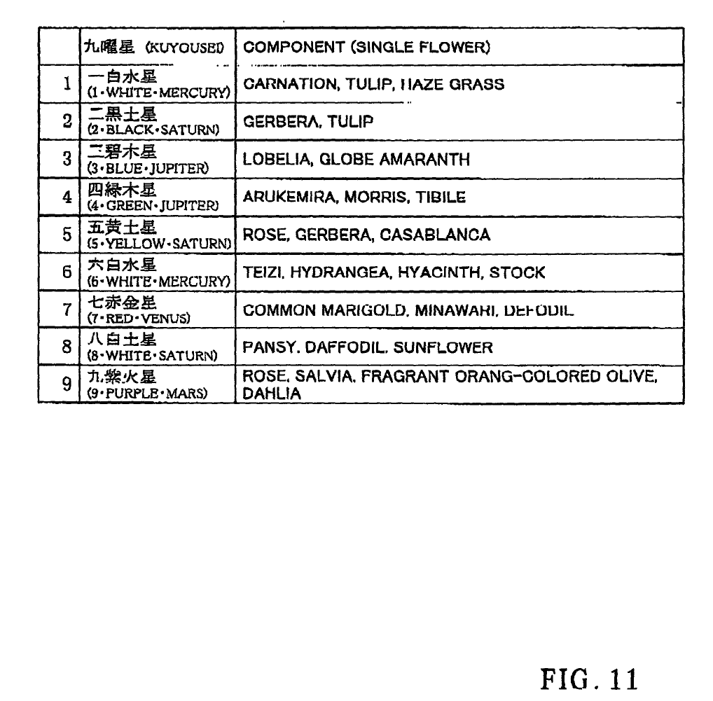

The aforementioned component storing portion 4 stores components (single flowers and flower shapes) of combination flowers in a file format in the state that each component is correlated with the element constituting the customer information ( [symbol] (KUYOUSEI) or purpose of use). The aforementioned file includes a file in which single flowers are listed in a state of being correlated with each element of [symbol] (KUYOUSEI) as shown in FIG. 11 and a file in which single flowers and flower shapes are listed in a state of being correlated with each purpose of use as shown in FIG. 12.

The aforementioned [symbol] (KUYOUSEI) is a classification for telling a person's fortune which is classified into nine items to which a person's birthday will be allotted, i.e., [symbol] (1.WHITE.MERCURY), [symbol] (2.BLACK.SATURN), [symbol] (3.BLUE.JUPITER), [symbol] (4.GREEN.JUPITER), [symbol] (5.YELLOW.SATURN), [symbol] (6.WHITE.MERCURY), [symbol] (7.RED.VENUS), [symbol] (8.WHITE.SATURN) and [symbol] (9.PURPLE.MARS).

The dealer information storing portion 5 stores information concerning each dealer Bn (hereinafter referred to as “dealer information”) in a file format. This dealer information file includes a dealer's name, address, telephone number, FAX number, person-in-charge name and e-mail address. This control portion 2 is comprised of CPUs, etc., and controls each portion, displays a guidance screen, transfers data, conducts various calculations, stores data temporarily, etc. The control portion 2 has a dealer information input function, a customer information input function, a flower combination function, a combination items information output function for customers, a combination items information output function for dealers and a settlement of accounts function.

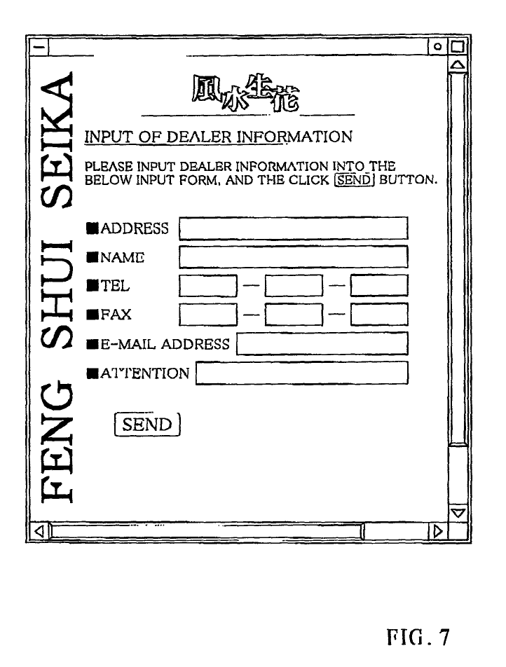

The dealer information input function is a function to display a dealer information input screen as shown in FIG. 7 on a display of a personal computer bn of a dealer Bn, to promote an input of dealer information from dealers Bn and to store the inputted dealer information in the dealer information storing portion 5.

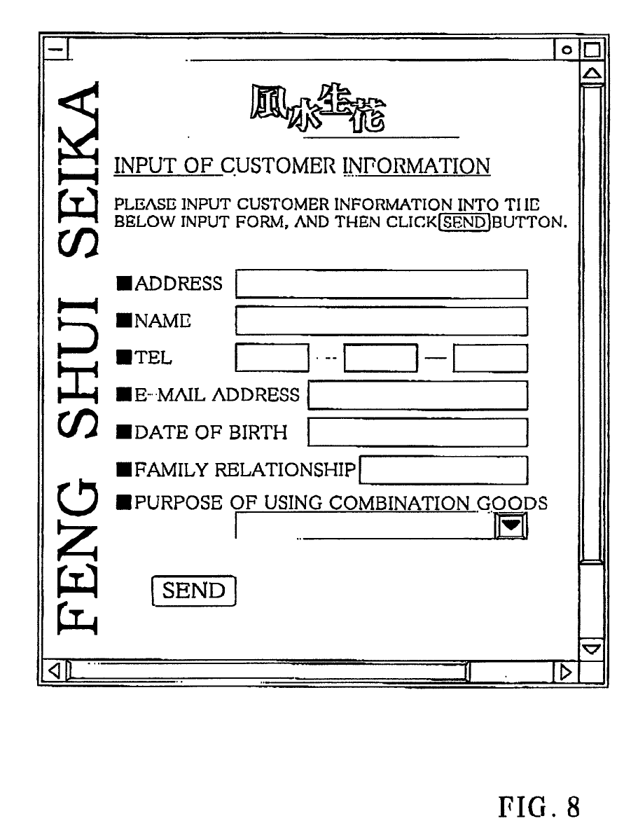

The customer information input function is a function to display a customer information input screen as shown in FIG. 8 on a display of a personal computer an of a customer An, to promote an input of customer information from customers An and to store the inputted customer information in the customer information storing portion 3.

The flower combination function is a function to create combination flowers by selectively combining components (single flowers and flower shapes) stored in the component storing portion 4 based on the customer information stored in the customer information storing portion 3.

For example, in a case where the aforementioned [symbol] (KUYOUSEI) specified by a birth date of a customer An corresponds to “ [symbol] (2.BLACK.SATURN)” and the purpose for using the combination flowers is “Luck with Money,” the flower combination function will create information on combination flowers as follows: Single flowers (Gerbera, Tulip) corresponding to “ [symbol] (2.BLACK.SATURN)” and single flowers (Patrinia scabiosaefolia, Marigold) and flower shape (Free shape) each corresponding to the “Luck with Money” will be selected from the component storing portion 4, and then these selected single flowers (Gerbera, Tulip, Patrinia scabiosaefolia and Marigold) are combined in accordance with the selected flower shape to create information on combination flowers.

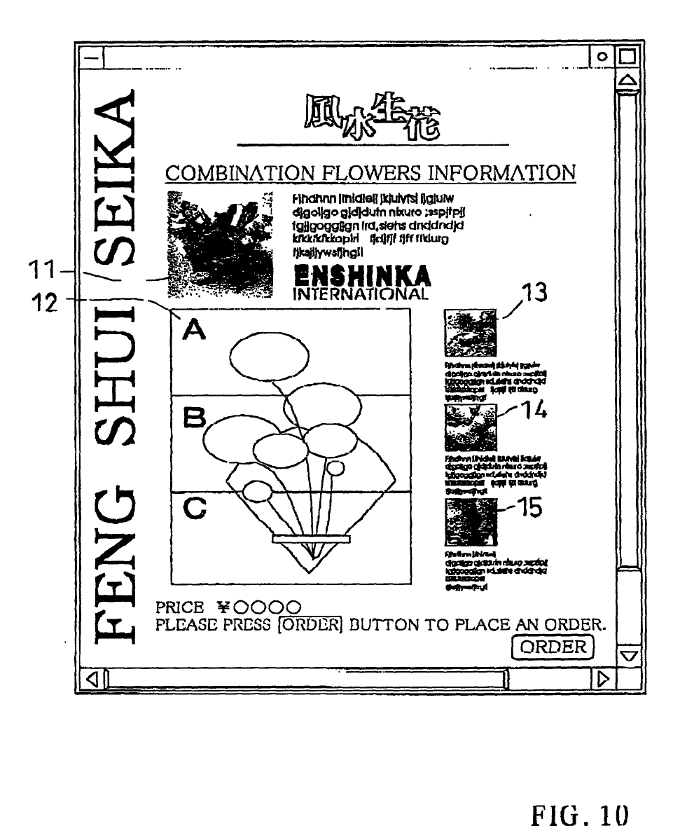

The combination items information output function for customers is a function to display a combination items (flowers) information screen showing the outline, explanations and price of the combination items (flowers) as shown in FIG. 10 on a display of a personal computer an of a customer An, to wait a purchase order from the customer An.

In this information screen, the photograph 11 shows sample combination flowers, the FIG. 12 illustrates a schematic shape of the combination flowers, and the photographs 13, 14 and 15 show each single flower in section A, section B and section C in the FIG. 12, respectively.

If the “ORDER” button in the information screen is clicked with the mouse cursor when the customer An places a purchase order for the combination flowers through the information screen, the server C can confirm the purchase order.

The combination items information output function for dealers is a function to display a combination items (flowers) information screen on a display of a personal computer bn of a dealer Bn as shown in FIG. 10, and to invite the dealer Bn to dispatch the combination flowers.

The accounts settlement function is a function to settle the accounts by transmitting a credit card number of a customer's credit card to a credit card company (not shown) when a purchase order from a customer An is confirmed. The credit card number of the customer's An credit card is previously stored in the customer information storing portion 3 of the server C.

Next, the procedures for registering a dealer and those for placing a purchase order for combination flowers will be explained.

(Procedure for Registering a Dealer)

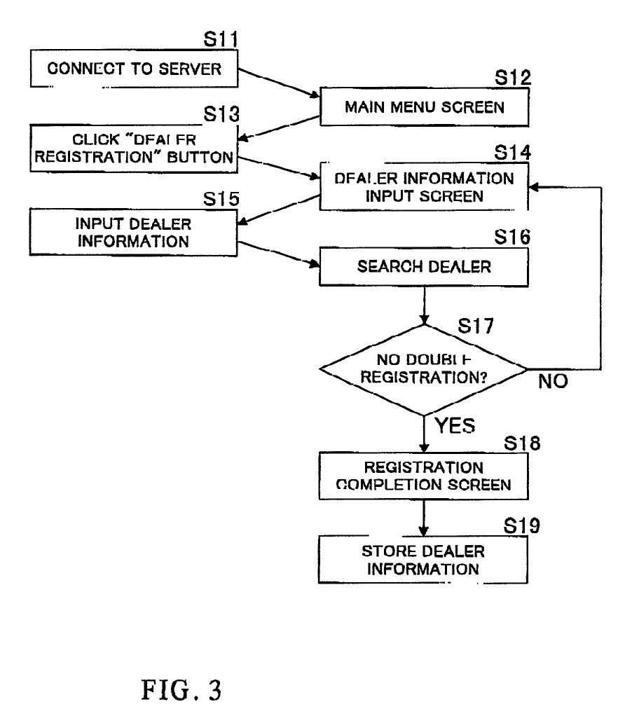

First, the procedure of dealer registration will be explained with reference to the flow chart shown in FIG. 3.

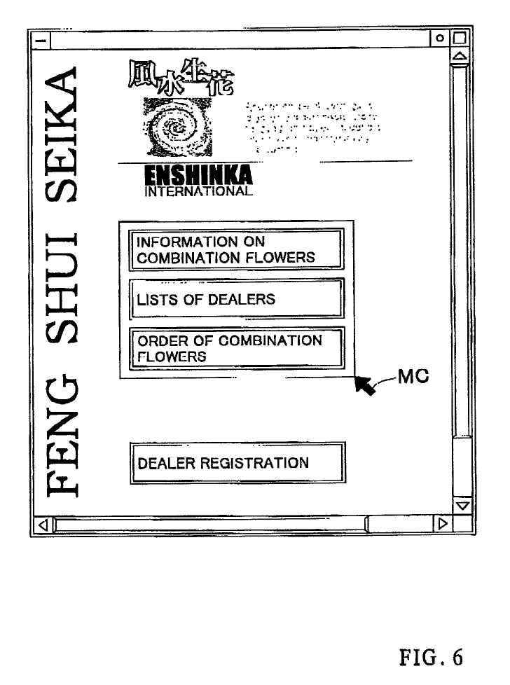

When a dealer Bn connects its personal computer bn to the server C via the Internet I in Step (hereinafter simply referred to as “S”) 11, the server C causes the display of the personal computer bn of the dealer Bn to display the main menu screen as shown in FIG. 6 in S12.

In this main menu screen, a mouse cursor MC is displayed, and various processing can be performed by clicking a predetermined portion on the screen. For example, when the “Guide to Combination Flowers” button is clicked with the mouse cursor MC, the guide screen of the combination flowers will be displayed. When the “Lists of Dealers” button is clicked, the lists of registered dealers Bn will be displayed.

Then, when a dealer Bn selects the processing of dealer registration by clicking the “Dealer registration” button in the main menu screen with the mouse cursor MC in S13, the server C which detected the above selection causes the display of a personal computer bn to display a dealer information input screen as shown in FIG. 7 in S14.

Then, after the dealer Bn inputs its “address,” name,” “telephone number,” “FAX number,” “e-mail address,” and “person-in-charge name” in the dealer information input screen, respectively, the dealer Bn clicks the “SEND” button with the mouse cursor MC to transmit the dealer information to the server C in S15.

After this operation, in order to prevent a double registrations of the dealer, the server C searches the dealer in the dealer information storing portion 5 to judge whether or not the dealer Bn has been already registered in S16.

If it is judged that the registration causes a duplicate registration (Yes in S17), the server C causes the display of the personal computer bn of the dealer Bn to display a warning screen such as “Duplication registration is being performed,” and thereafter causes the display of the personal computer bn of the dealer Bn to display a dealer information input screen again so as to invite the dealer Bn to re-input dealer information (S14).

On the other hand, if it is judged that the registration will not cause a duplicate registration (No in S17), the server C causes the display of the personal computer bn of the dealer Bn to display the screen “Completion of Registration.” Thereafter, the inputted dealer information is stored in the dealer formation storing portion 5 as a dealer information file (S19).

Thus, since a dealer Bn can perform a dealer registration easily through the Internet (I) from the personal computer bn thereof, the business network of the dealer bn can be easily expanded.

(Procedures for Placing a Purchase Order for Combination Flowers)

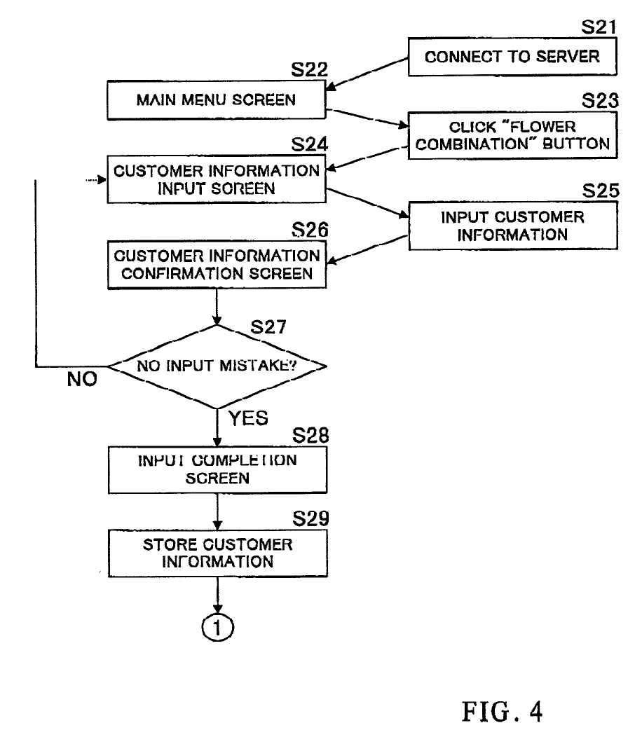

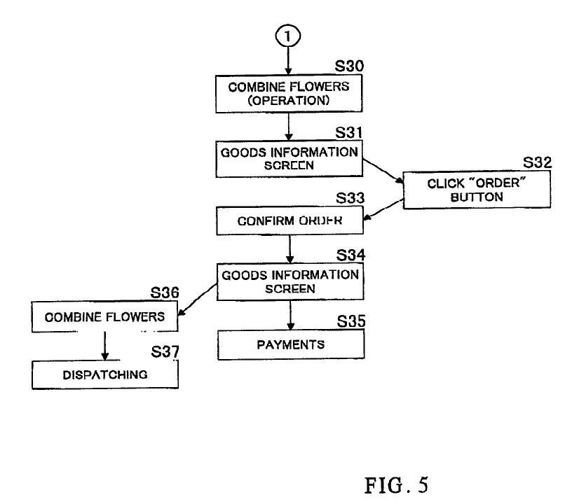

Next, the procedures for placing a purchase order for combination flowers will be explained with reference to the flow chart shown in FIGS. 4 and 5.

When a customer An connects his/her personal computer an to the server C via the Internet I (S21), the server C causes the personal computer an of the customer An to display the main menu screen as shown in FIG. 6 (S22).

when the customer An selects the processing of combination flowers by clicking the “Order of Combination Flowers” button with the mouse cursor MC, the server C which detected the above selection of the processing causes the display of the personal computer an of the customer An to display the customer information input screen as shown in FIG. 8 (S24).

In this customer information input screen, the customer An inputs his/her “Address,” “Name,” “Telephone number,” “E-mail address,” “Birth date,” “Family relationship” and “Purpose for using the combination flowers.” Thereafter, the customer An transmits the customer information to the server C by clicking the “SEND” button with the mouse cursor MC (S25).

The customer's “Address,” “Name,” “Telephone number,” “E-mail Address,” “Birth Date” and “Family Relationship” are inputted by the customer An via the keyboard. The “Purpose for using the combination flowers” is inputted by clicking one of the listed purposes (in this embodiment, 21 purposes are available) with the mouse cursor MC.

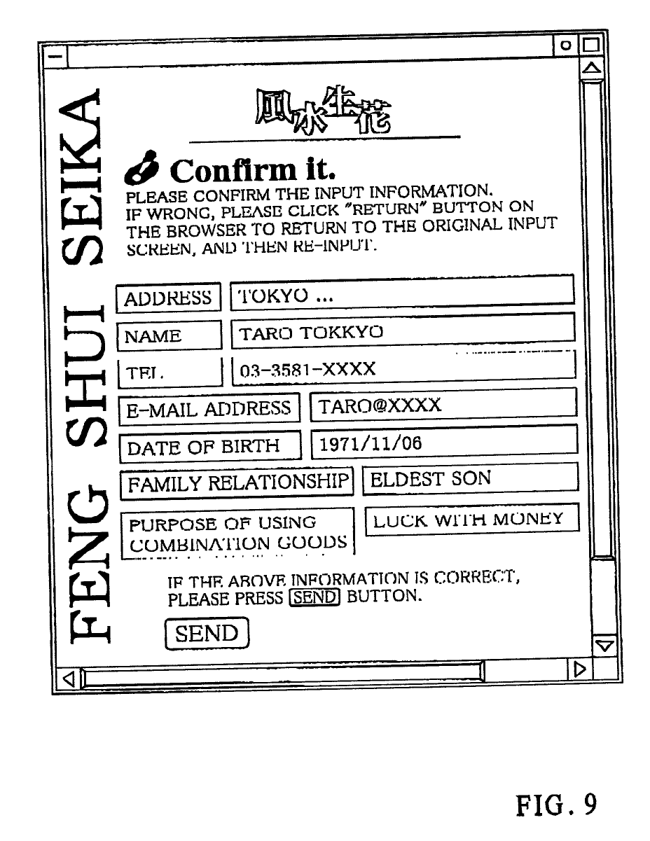

After the aforementioned processing, the server C causes the display of the personal computer an of the customer An to display the customer information confirmation screen as shown in FIG. 9 to urge the confirmation by the customer An (S26).

If the customer information includes input mistakes (Yes in S27), the server C causes the display of the personal computer an of the customer An to display the customer information input screen again in accordance with the predetermined operation by the customer An (S24). On the other hand, if the customer information includes no input mistake (No in S27), the server C causes the display of the personal computer an of the customer An to display a screen such as “Input completed” in accordance with the predetermined operation by the customer An (S28).

Thereafter, the server C stores the inputted customer information into the customer information storing portion 3 as a customer information file (S29).

Then, the server C creates information on combination flowers by selectively combining the components (single flowers and flower shapes) picked up from the component storing portion 4, based on the customer information stored in the customer information storing portion 3 (S30).

For example, in a case where the aforementioned [symbol] (KUYOUSEI) specified by a birth date of a customer An corresponds to “ [symbol] (2.BLACK.SATURN)” and the purpose for using the combination flowers is “Luck with Money,” the control portion 2 will create information on combination flowers as follows: Single flowers (Gerbera, Tulip) corresponding to the “ [symbol] (2.BLACK.SATURN)” and single flowers (Patrinia scabiosaefolia, Marigold) and flower shape (Free shape) each corresponding to the “Luck with Money” will be selected from the component storing portion 4, and then these selected single flowers (Gerbera, Tulip, Patrinia scabiosaefolia and Marigold) are combined in accordance with the selected flower shape to create information on combination flowers.

Then, the server C causes the display of the personal computer an of the customer An to display combination items (flowers) information screen including outlines, explanations and price of combination flowers as shown in FIG. 10, to urge a purchase order decision from the customer An (S31).

When the customer An places a purchase order for the combination flowers after confirming the combination items (flowers) information, a purchase order signal will be transmitted to the server C by clicking the “ORDER” button on the combination items (flowers) information screen with the mouse cursor MC (S32). Then, the server C will confirm the order (S33).

In this way, the server C confirmed the order causes the display of the personal computer bn of the predetermined dealer Bn to display the combination items (flowers) information screen shown in FIG. 10 (S34), and to transmit the credit number of the customer An to a credit card corporation to settle the accounts (S35).

Thereafter, the dealer Bn actually creates the combination flowers based on the combination items (flowers) information screen (S36), and then dispatches the created combination flowers to the customer An (S37).

With this system, since combination flowers will be created by selectively combining compositions which constitute combination flowers (i.e., single flowers and flower shape) based on the customer information, the customer An can place a purchase order for appropriate combination flowers, which enhances the customer's incentive to a purchase order.

In this embodiment, although a customer An inputs information concerning the customer An via his/her personal computer an, a customer An may convey such information to a dealer Bn in words or by a written document, and then the dealer Bn may input the customer information into the dealer's personal computer bn.

Furthermore, in the aforementioned embodiment, although the inputted customer information includes the customer's address, name, telephone number, e-mail address, birth date, family relationship and the purpose of using the combination flowers, there may be more or less elements than the aforementioned elements, provided that the information includes at least one of aforementioned elements.

Furthermore, in the aforementioned embodiment, although a personal computer is used as a communication terminal, another communication terminal connectable with computer networks, such as a cellular phone and a personal handyphone (PHS), may also be used.

Furthermore, in the aforementioned embodiment, although the combination items (flowers) information screen as shown in FIG. 10 is displayed on a customer's personal computer an, such combination items (flowers) information screen may not be displayed.

Furthermore, in the aforementioned embodiment, although the aforementioned combination items (flowers) information screen includes a sample photograph of combination flowers, a schematic drawing of the flower shape, a photograph of a single flower corresponding to the schematic drawing of the flower shape and the price, another information may also be displayed. For example, another information may be the contents of the combination flowers and the explanation concerning the place where the combination flowers is to be displayed.

Furthermore, in the aforementioned embodiment, although the purpose for using the combination flowers can be selected from 21 purposes as shown in FIG. 12, another purposes may be added. For example, the purpose for using the combination flowers may include “Birthday Present,” “Birth Celebration,” “Baby Shower,” “Housewarming Present,” “Celebration party and other Commemoration formula,” “exhibitions such as Piano exhibition,” “Present to Sweetheart,” and “Marriage Ceremony.”

Furthermore, each purpose of use shown in FIG. 12 may include more specific purposes. For example, “1. PROSPERITY IN BUSINESS” may include more specifically defined purposes classified by occupation. “9. FAMILY CORRECTION” may include more specifically defined purposes concerning the displaying places, and “10. HEALTHY RECOVERY” may include more specifically defined purposes classified by illness.

Furthermore, the relationship between [symbol] (KUYOUSEI) and single flowers and the relationship between the purpose of use and single flowers/shapes may be set up based on a predetermined rule, respectively, or may be set up arbitrarily.

The aforementioned predetermined rule includes a statistical rule based on [symbol] (Feng Shui Theory) handed down from ancient times in the East Asia.

Furthermore, in the aforementioned embodiment, although the dealer registration is performed through the Internet I from the personal computer bn of the dealer Bn, the dealer registration may be performed by off-line processing. In detail, a dealer Bn may notify the dealer information to a system operator (Guardian of a Server C) by off-line such as a mail, and the system operator may operate the terminal computer to perform the dealer registration.

Furthermore, in the aforementioned embodiment, although customers An, dealers Bn and the server C are connected via the Internet I, they may be connected via a computer network, such as a telephone-line network, an ISDN line network and a private line network.

Furthermore, in the aforementioned embodiment, although flowers are used as the components of combination items, another items which are capable of being selectively combined can also be used as components of combination items.

Furthermore, in the aforementioned embodiment, although the items combination apparatus is applied to a server C, and connected with customers An and dealers Bn via the Internet, the items combination apparatus may be located at a dealer Bn. In this case, the customer information input function causes input operation of customer information directly from a keyboard and/or a mouse connected to the items combination apparatus, the items information output function causes the display connected to the items combination apparatus to directly display the items information of combination flowers. In this system, a customer An conveys the customer information to a dealer Bn in words or by a written document, and then the dealer Bn inputs the customer information into the items combination apparatus using a keyboard and/or a mouse.

Then, the items combination apparatus performs a flower combination by selectively combining components (single flowers and flower shapes) based on the inputted customer information. Thereafter, the apparatus causes the display to display the items information screen of combination flowers.

Furthermore, although an items combination apparatus including a server C usually performs items combination by the items combination program stored in the apparatus, the combination may be performed by programs stored in another storage media. The program executes the following means: customer information input means which inputs information concerning a customer; customer information storing means which stores the information concerning the customer inputted by the customer information input means; items constituting element storing means which stores information concerning combination items constituting elements; combination items information creating means which creates information concerning combination items suitable for the customer by selectively combining the combination items constituting elements stored in the items constituting element storing means based on the information concerning the customer stored in the customer information storing means; and combination items information output means which outputs the information concerning the combination items created by the combination items information creating means.

This application claims priority to Japanese Patent Application No. 2000-166567 filed on Jun. 2, 2000, the disclosure of which is incorporated by reference in its entirety.

The terms and descriptions in this specification are used only for explanatory purposes and the present invention is not limited to these terms and descriptions. It should be appreciated that there are many modifications and substitutions without departing from the spirit and the scope of the present invention which is defined by the appended claims.

What is claimed is:

1. A system for generating a purchase order for combination items based on information concerning a customer, the system, comprising:
customer information input means which inputs information concerning a customer;
customer information storing means which stores said information concerning said customer inputted by said customer information input means;
components storing means which stores information concerning components constituting said combination items;
combination items information creating means which creates information concerning said combination items suitable for said customer by selectively combining said components stored in said components storing means based on said information concerning said customer stored in said customer information storing means; and
combination items information output means which outputs said information concerning said combination items created by said combination items information creating means.

2. The system as recited in claim 1, wherein said customer information input means inputs said information concerning said customer transmitted through a computer network from a communication terminal of said customer, and wherein said combination items information output means outputs said information concerning said combination items to said communication terminal of a dealer through said computer network.

3. The system as recited in claim 2, wherein said combination items information output means also outputs said information concerning said combination items to said communication terminal of said customer through said computer network.

4. The system as recited in claim 2, further comprising dealer information storing means which stores information concerning a dealer transmitted through said computer network from said communication terminal of said dealer, wherein said combination items information output means outputs said information concerning said combination items to said communication terminal of said dealer through said computer network based on said information concerning said dealer stored in said dealer information storing means.

5. The system as recited in claim 3, further comprising dealer information storing means which stores information concerning a dealer transmitted through said computer network from said communication terminal of said dealer, wherein said combination items information output means outputs said information concerning said combination items to said communication terminal of said dealer through said computer network based on said information concerning said dealer stored in said dealer information storing means.

6. The system as recited in any one of claims 1 to 5, wherein said information concerning said customer includes customer information including a customer's name and address and a purpose for using said combination items.

7. The system as recited in any one of claims 1 to 5, wherein said combination items are combination flowers and said components are a single flower and a flower type.

8. The system as recited in any one of claims 1 to 5, wherein said combination items are combination flowers and said components are a single flower and a flower type, and wherein said information concerning said customer includes customer information including a customer's name and address and a purpose for using said combination items.

9. A storage media in which a program for creating information on combination items is recorded, said program executes the following means:
customer information input means which inputs information concerning a customer;
customer information storing means which stores said information concerning said customer inputted by said customer information input means;
components storing means which stores information concerning components of combination items;
combination items information creating means which creates information concerning combination items suitable for said customer by selectively combining said components constituting combination items stored in said items constituting element storing means based on said information concerning said customer stored in said customer information storing means; and
combination items information output means which outputs said information concerning said combination items created by said combination items information creating means.

10. A method of ordering combination items, comprising:
inputting information concerning a customer into a computer;
creating information concerning combination items by selectively combining components constituting said combination items based on said information concerning said customer by said computer; and
outputting said information concerning said combination items to a terminal of a dealer, whereby said dealer creates combination items based on said information concerning said combination items and provides said created combination items to said customer.

11. The method for ordering combination items as recited in claim 10, wherein said computer creates information concerning said combination items by a program recorded in a storage media for creating combination items.

12. The method for ordering combination items an recited in claim 11, wherein said customer inputs said information concerning said customer into said computer through a computer network.

13. The method for ordering combination items as recited in claim 10, wherein said computer outputs said information concerning said combination items to said dealer through a computer network.

14. A server system for generating a purchase order for combination items, comprising:
customer information storing means which stores information concerning a customer transmitted from a customer system;
combination items component storing means which stores information concerning components of said combination items;
combination items information creating means which creates information concerning combination items by selectively combining components stored in said component storing means based on said information concerning said customer stored in said customer information storing means; and
information output means which outputs said information concerning said combination items to said customer system,
wherein said server system generates an order of said combination items according to an instruction from said customer system.

15. A method for ordering combination items, comprising:
transmitting predetermined information to a server system through a computer network from a customer system;
in said server system:
receiving said predetermined information;
creating information concerning combination items by selectively combining each previously stored information concerning components constituting said combination items based on said predetermined information; and
transmitting said information concerning combination items to said customer system through said computer network;
in said customer system:
receiving said information concerning combination items;
generating a purchase order for said combination items; and
transmitting said order to said server system.

16. The method for ordering combination items as recited in claim 15, wherein said predetermined information includes information concerning a customer including a customer's name and address and a purpose for using said combination items.

17. The method for ordering combination items as recited in claim 15, wherein said combination items are combination flowers.

18. A method for receiving a purchase order for combination items, comprising:
inputting information concerning a dealer into a server system through a computer network; and
inputting predetermined information into said server system through said computer network from a customer system;
in said server system:
creating information concerning combination items by selectively combining each previously stored information concerning components constituting said combination items based on said predetermined information; and
transmitting said information concerning said combination items to said customer system through said computer network,
in the customer system:
receiving information concerning said combination items;
generating a purchase order of said combination items; and
transmitting said purchase order to said server system,
in said dealer system:
receiving said purchase order.

19. The method for ordering combination items as recited in claim 18, wherein said predetermined information includes information concerning a customer including a customer's name and address and a purpose for using said combination items.

20. The method for ordering combination items as recited in claim 18, wherein said combination items are combination flowers.
